(19) United States
(12) Patent Application Publication
(10) Pub. No.: US 2021/0063928 A1
(43) Pub. Date: Mar. 4, 2021

(54) FIXING DEVICE AND IMAGE FORMING APPARATUS

(71) Applicant: KYOCERA Document Solutions Inc., Osaka (JP)

(72) Inventors: Masakazu UEHARA, Osaka-shi (JP); Hironori TAKAHASHI, Osaka-shi (JP); Tomohiro WATATANI, Osaka-shi (JP); Yuhiro SAKAI, Osaka-shi (JP); Fumito NAKAMOTO, Osaka-shi (JP)

(73) Assignee: KYOCERA Document Solutions Inc., Osaka (JP)

(21) Appl. No.: 17/006,453

(22) Filed: Aug. 28, 2020

(30) Foreign Application Priority Data
Aug. 30, 2019 (JP) 2019-158385

(51) Int. Cl. G03G 15/20

(52) U.S. Cl. CPC G03G 15/2053; G03G 2215/2035; G03G 15/2064

(57) ABSTRACT

A fixing device includes a fixing belt and a heating section. The heating section includes a heater and a heater holding member. The heater holding member has a main body portion and a plurality of ridges. The ridges include a plurality of first ridges and a plurality of second ridges. The first ridges are disposed on a central portion of the main body portion in a width direction of the fixing belt. The second ridges are disposed in an area of the main body portion at least partially extending, in the width direction of the fixing belt, from the central portion to each of opposite ends of the main body portion. The first ridges are disposed separated at a first interval. The second ridges are disposed separated at a second interval. The first interval is smaller than the second interval.

### INCORPORATION BY REFERENCE

The present application claims priority under 35 U.S.C. § 119 to Japanese Patent Application No. 2019-158385, filed on Aug. 30, 2019. The contents of this application are incorporated herein by reference in their entirety.

### BACKGROUND

The present disclosure relates to a fixing device and an image forming apparatus.

An electrographic image forming apparatus includes a fixing device which fixes a toner image to paper. The fixing device includes a fixing assembly and a pressure roller. The pressure roller forms a fixing nip section by pressing against the fixing assembly.

The fixing assembly includes a fixing film, a heater, a heat insulating holder, and a metal frame stay. The fixing film is cylindrical. The fixing film passively rotates according to rotational driving of the pressure roller. The heater is in contact with an inner surface of the fixing film and applies heat to the fixing film. The heat insulating holder holds the heater. The metal frame stay presses the heat insulating holder against the pressure roller. The heat insulating holder has a plurality of ribs. Each rib protrudes from a side wall of the heat insulating holder in a direction orthogonal to a width direction of the fixing film. The ribs are disposed at an equal interval in the width direction of the fixing film. The ribs all have the same height. The height of the ribs indicates a length to which the ribs protrude from the side wall of the heat insulating holder in the direction orthogonal to the width direction of the insulating film. The ribs maintain the shape of the fixing film as the fixing film rotates.

### SUMMARY

A fixing device according to an aspect of the present disclosure includes a fixing belt and a heating section. The fixing belt is endless. The heating section faces an inner peripheral surface of the fixing belt. The heating section includes a heater and a heater holding member. The heater applies heat to the fixing belt. The heater holding member holds the heater. The heater holding member has a main body portion and a plurality of ridges. The ridges regulate a shape of the fixing belt. The ridges protrude from the main body portion. The ridges include a plurality of first ridges and a plurality of second ridges. The first ridges are disposed on a central portion of the main body portion in a width direction of the fixing belt. The second ridges are disposed in an area of the main body portion at least partially extending, in the width direction of the fixing belt, from the central portion to each of opposite ends of the main body portion. The first ridges are disposed separated at a first interval. The second ridges are disposed separated at a second interval. The first interval is smaller than the second interval.

An image forming apparatus according to an aspect of the present disclosure includes the above fixing device and an image forming section. The image forming section forms a toner image on a recording medium. The fixing device fixes the toner image to the recording medium.

### BRIEF DESCRIPTION OF THE DRAWINGS

FIG. 1 is a diagram illustrating an image forming apparatus according to an embodiment of the present disclosure.

FIG. 2 is a perspective view of a main section of a fixing device according to the embodiment of the present disclosure.

FIG. 3 is an exploded perspective view of the fixing device according to the embodiment of the present disclosure.

FIG. 4 is a cross-sectional view taken along a line IV-IV in FIG. 2.

FIG. 5A is a perspective view of a heater holding member.

FIG. 5B is an enlarged view of a first area R1 in FIG. 5A.

FIG. 6A is a diagram illustrating the heater holding member and belt holding sections as viewed from a negative X-axial direction.

FIG. 6B is an enlarged view of a second area R2 in FIG. 6A.

FIG. 7A is a partial cross-sectional view taken along a line VIIA-VIIA in FIG. 2.

FIG. 7B is an enlarged partial cross-sectional view of ridges and a fixing belt of the present embodiment in a central portion of the heater holding member in a Y-axial direction in a state where the fixing device is still.

FIG. 7C is an enlarged partial cross-sectional view of the ridges and the fixing belt of the present embodiment in the central portion of the heater holding member in the Y-axial direction in a state where the fixing device is being driven.

FIG. 7D is an enlarged partial cross-sectional view of ridges and a fixing belt of a comparative example in the central portion of a heater holding member in the Y-axial direction in a state where a fixing device is being driven.

FIG. 8A is an enlarged view of a first end of the heater holding member as viewed from a positive Z-axial direction.

FIG. 8B is a diagram illustrating the first end of the heater holding member as viewed from the negative X-axial direction.

FIG. 9A is a cross-sectional view of a state where the heater holding member is being inserted into the fixing belt from a side of a second end of the heater holding member.

FIG. 9B. is a cross-sectional view of a state where the heater holding member has been inserted into the fixing belt.

### DETAILED DESCRIPTION

The following describes an embodiment of the present disclosure with reference to the accompanying drawings. Note that elements that are the same or equivalent are labeled with the same reference signs in the drawings and description thereof is not repeated. In the present embodiment, the drawings feature mutually orthogonal X, Y, and Z axes. The Z axis is parallel to a vertical line, and the X and Y axes are parallel to a horizontal plane.

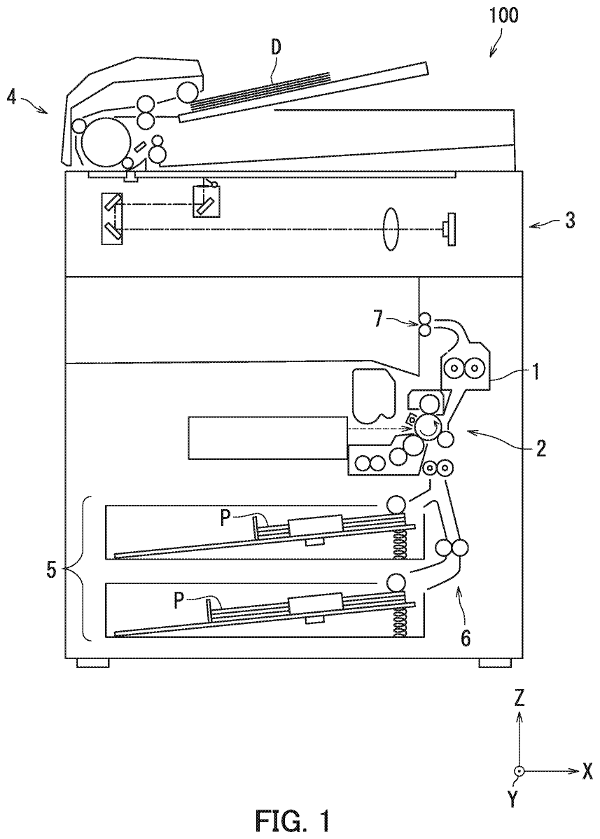

An image forming apparatus 100 according to the embodiment of the present disclosure is described with reference to FIG. 1. FIG. 1 is a diagram illustrating the image forming apparatus 100 in the present embodiment. Examples of the image forming apparatus 100 include a copier, a facsimile machine, and a multifunction peripheral having the functions of a copier and a facsimile machine. In the present embodiment, the image forming apparatus 100 is a monochrome multifunction peripheral.

As illustrated in FIG. 1, the image forming apparatus 100 includes a reading section 3, a document conveyance section 4, a paper feed section 5, a conveyance section 6, an image forming section 2, a fixing device 1, and an ejection section 7.

The reading section 3 reads an image from a document D. The reading section 3 generates image data from the read image. The document conveyance section 4 conveys the document D to the reading section 3. The paper feed section 5 houses multiple sheets of paper P. The paper feed section 5 feeds the paper P to the conveyance section 6. The paper P is made from paper or synthetic resin, for example. The paper P is an example of a recording medium. The conveyance section 6 includes a plurality of conveyance roller pairs. The conveyance section 6 conveys the paper P to the ejection section 7 via the image forming section 2.

The image forming section 2 electrographically forms a toner image on the paper P based on image data. The image data indicates the image from the document D, for example. The image forming section 2 includes for example a photosensitive drum, a charger, a light exposure device, a development device, a replenishing device, a transfer roller, a cleaning device, and a static elimination device.

The fixing device 1 applies heat and pressure to the toner image to fix the toner image to the paper P. The conveyance section 6 conveys the paper P with the toner image fixed thereto to the ejection section 7. The ejection section 7 ejects the paper P out of the casing of the image forming apparatus 100.

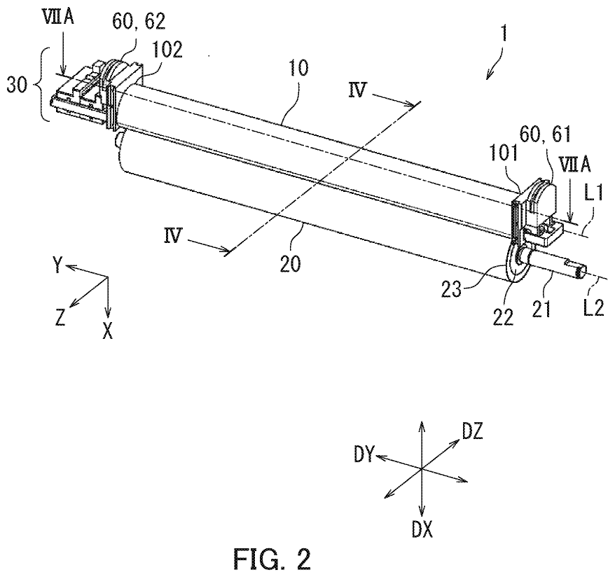

Next, a configuration of the fixing device 1 of the present embodiment is described in detail with reference to FIGS. 2 to 4. FIG. 2 is a perspective view of a main section of the fixing device 1 in the present embodiment.

As illustrated in FIG. 2, the fixing device 1 includes a fixing belt 10, a pressure member 20, a heating section 30, and a pair of belt holding sections 60.

The fixing belt 10 applies heat to the paper P with a toner image transferred thereto. The fixing belt 10 is an endless belt. The fixing belt 10 is substantially cylindrical. The fixing belt 10 is flexible. The fixing belt 10 freely rotates around a first rotational axis L1. The first rotational axis L1 is parallel to the Y axis. The fixing belt 10 extends along the first rotational axis L1.

A first direction DY is defined. The first direction DY is a direction DY in which the first rotational axis L1 extends. In the following, the first direction DY may be referred to as a “width direction DY of the fixing belt 10”. Also in the following, a side on which the heating section 30 is disposed in the first direction DY may be referred to as “one side in the first direction DY”, and the opposite side thereto may be referred to as the “other side in the first direction DY”.

The fixing belt 10 has a plurality of layers. The fixing belt 10 has a polyimide layer and a release layer, for example. The release layer is formed on an outer circumferential surface of the polyimide layer. The release layer is a heat resistant film made from fluororesin, for example.

The fixing belt 10 has a first edge 101 and a second edge 102. The first edge 101 is an edge on the other side of the fixing belt 10 in the first direction DY. The second edge 102 is an edge on the one side of the fixing belt 10 in the first direction DY.

The pair of belt holding sections 60 rotatably holds the fixing belt 10. In detail, the pair of belt holding sections 60 includes a first holding member 61 and a second holding member 62. The first holding member 61 is attached to the first edge 101 of the fixing belt 10. The second holding member 62 is attached to the second edge 102 of the fixing belt 10.

The pressure member 20 applies pressure to the fixing belt 10 and the paper P with a toner image fixed thereto. In detail, the pressure member 20 is substantially cylindrical and is disposed opposite to the fixing belt 10. The pressure member 20 is pressed to the fixing belt 10. In other words, the pressure member 20 applies pressure to the fixing belt 10. The pressure member 20 is a pressure roller, for example. The pressure member 20 extends in the first direction DY.

The pressure member 20 includes a metal core 21, an elastic layer 22, and a release layer 23. The metal core 21 is columnar. The elastic layer 22 is formed on the metal core 21. The elastic layer 22 is cylindrical. The release layer 23 is formed so as to cover the surface of the elastic layer 22. The metal core 21 freely rotates around a second rotational axis L2. The second rotational axis L2 is substantially parallel to the first rotational axis L1. Examples of the material of the metal core 21 include stainless steel and aluminum. The elastic layer 22 is elastic. The material of the elastic layer 22 is silicone rubber, for example. The material of the release layer 23 is fluororesin, for example.

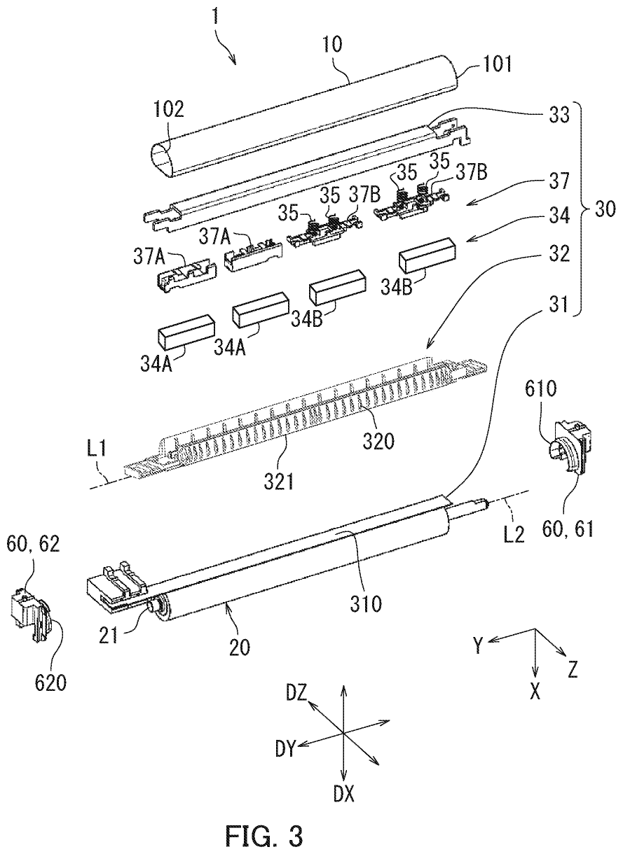

FIG. 3 is an exploded perspective view of the fixing device 1 in the present embodiment. As illustrated in FIG. 3, the heating section 30 includes a heater 31, a heater holding member 32, a reinforcing member 33, a plurality of heat-sensitive bodies 34, and a plurality of cover members 37.

The heater 31 applies heat to the fixing belt 10. The heater 31 extends in the first direction DY. Specifically, the heater 31 has a heater surface 310. The heater surface 310 is planar or long and thinly plate-shaped. Examples of the heater 31 include a planar heater and a long and thin plate heater. The heater 31 is a ceramic heater, for example. A ceramic heater includes a ceramic substrate and a resistive heating element. The heater 31 is 1 mm in thickness, for example.

A second direction DX and a third direction DZ are defined. The second direction DX is a direction orthogonal to the heater surface 310 of the heater 31. The second direction DX is parallel to the X axis. In the second direction DX, the side on which the pressure member 20 is disposed may be referred to as “one side in the second direction DX” and the opposite side thereto may be referred to as the “other side in the second direction DX”. The third direction DZ is a direction orthogonal to the first direction DY and the second direction DX. The third direction DZ is parallel to the Z axis.

The heater holding member 32 holds the heater 31. The heater holding member 32 is made from heat-resistant resin, for example. The heater holding member 32 extends in the first direction DY. Of two ends of the heater holding member 32 in the first direction DY, the end near the second edge 102 of the fixing belt 10 is, for example, can be directly or indirectly fitted to a connector disposed on the main body of the image forming apparatus 100.

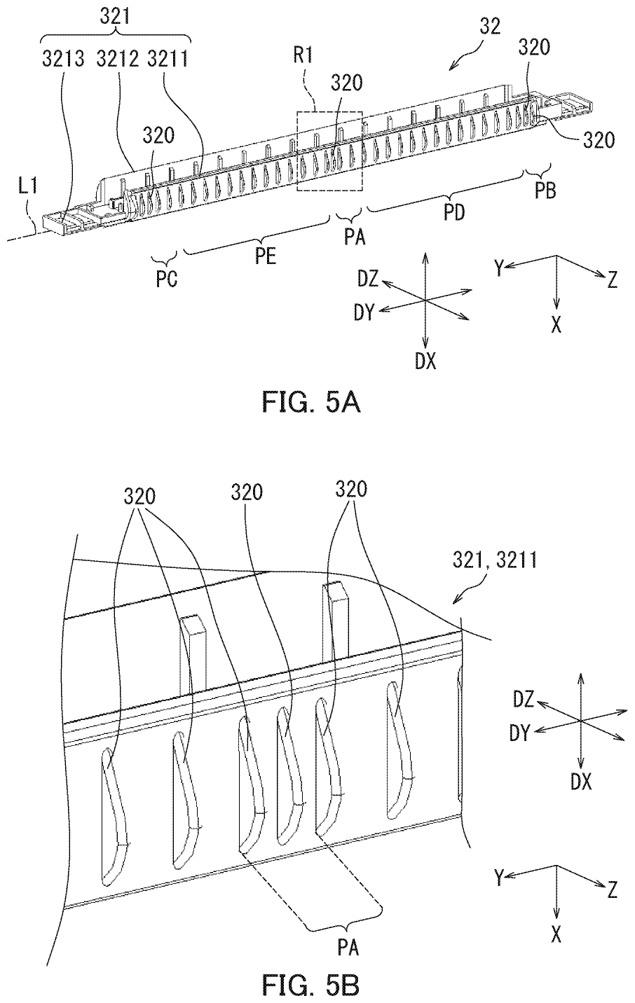

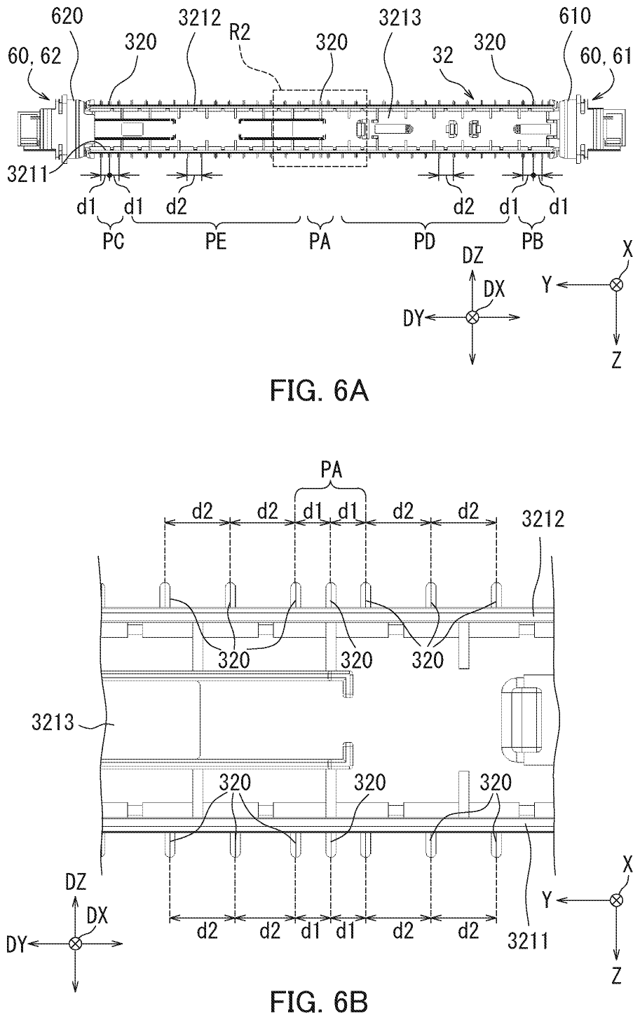

The heater holding member 32 has a main body portion 321 and a plurality of ridges 320. The ridges 320 regulate the shape of the fixing belt 10 during driving of the fixing device 1. The ridges 320 protrude from the main body portion 321. The heater holding member 32 is described in detail later with reference to FIGS. 5A to 6B.

The heat-sensitive bodies 34 sense the heat of the heater 31. The heat-sensitive bodies 34 are opposite to the heater 31. The heat-sensitive bodies 34 are disposed on the heater holding member 32. For example, a central portion of each heat-sensitive body 34 is inserted into a corresponding opening formed in the heater holding member 32, and is adjacent to the heater 31. The heat-sensitive bodies 34 include first heat-sensitive bodies 34A and second heat-sensitive bodies 34B.

Each heat-sensitive body 34 includes a thermocut, a thermostat, or a thermistor. A thermocut is a protection element such as a one-shot thermostat. The thermocut interrupts the supply of electricity to the heater 31 when the temperature of the heater 31 is equal to or greater than a threshold. In the thermocut, once the supply of electricity has been interrupted according to the temperature of the heater 31, the supply of electricity is not restored. A thermostat interrupts the supply of electricity to the heater 31 when the temperature of the heater 31 is equal to or greater than a threshold. When the temperature of the heater 31 is less than the threshold, the thermostat restores the supply of electricity to the heater 31. A thermistor is a semiconductor element which measures the temperature of the heater 31. The image forming apparatus 100 controls the heater 31 based on the temperature measured by the thermistor.

The cover members 37 are opposite to the heater holding member 32 with the heat-sensitive bodies 34 therebetween. In detail, the cover members 37 overlap with the heater 31, the heater holding member 32, and the heat-sensitive bodies 34 in the second direction DX. A cover member 37 is for example a resin box-shaped member that has heat resistance. The cover members 37 each cover at least part of a corresponding one of the heat-sensitive bodies 34. The cover members 37 include first cover members 37A and second cover members 37B. Specifically, each first cover member 37A covers at least part of a first heat-sensitive body 34A. Furthermore, each second cover member 37B covers at least part of a second heat-sensitive body 34B.

A plurality of urging members 35 are attached to each second cover member 37B. The urging members 35 are coil springs, for example. The urging members 35 are cylindrical, conical, or barrel-shaped, for example. The urging members 35 are arranged in the first direction DY. Two urging members 35 are attached to each of the second cover members 37B. The two urging members 35 urge a corresponding second heat-sensitive body 34B via a corresponding second cover member 37B.

The reinforcing member 33 reinforces the heater holding member 32. The reinforcing member 33 is a long metal frame stay member, for example. The reinforcing member 33 has a substantial inverted U-shape in cross section as viewed from a side in the first direction DY. The reinforcing member 33 extends in the first direction DY. The reinforcing member 33 is fixed opposite to the heater holding member 32.

The first holding member 61 includes a contact section 610. The contact section 610 comes in contact with the fixing belt 10. The contact section 610 of the first holding member 61 has a substantial C-shape when viewed from a side in the first direction DY. The second holding member 62 has a contact section 620. The contact section 620 comes in contact with the fixing belt 10. The contact section 620 of the second holding member 62 has a substantial C-shape when viewed from a side in the first direction DY.

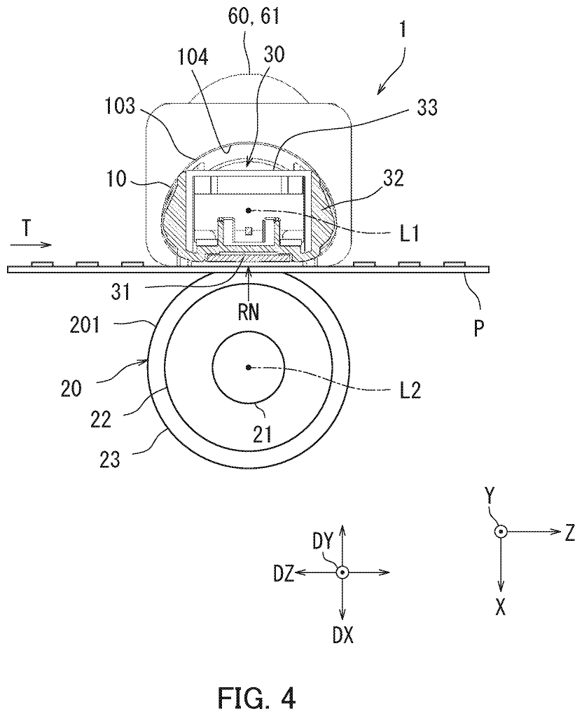

FIG. 4 is a cross-sectional view taken along a line IV-IV in FIG. 2. To facilitate understanding, a portion of the inside of the fixing belt 10 has been omitted from FIG. 4.

As illustrated in FIG. 4, the fixing belt 10 further has an outer circumferential surface 103 and an inner peripheral surface 104. The pressure member 20 has an outer circumferential surface 201. The outer circumferential surface 103 of the fixing belt 10 is in contact with the outer circumferential surface 201 of the pressure member 20 when there is no paper P in a fixing nip area RN. It should be noted that in FIG. 4, the outer circumferential surface 103 faces the outer circumferential surface 201 with the paper P therebetween.

The inner peripheral surface 104 of the fixing belt 10 faces the heating section 30. In other words, the heating section 30 is disposed in an inner space of the fixing belt 10. Specifically, the heater holding member 32 of the heating section 30 is disposed on a side of the inner peripheral surface 104 of the fixing belt 10. The heater holding member 32 is opposite to the fixing belt 10 with the heater 31 therebetween. The heater 31 receives pressure from the pressure member 20 through the fixing belt 10. The heater 31 receives pressure from the reinforcing member 33 through the heater holding member 32.

The outer circumferential surface 103 of the fixing belt 10 and the outer circumferential surface 201 of the pressure member 20 form the fixing nip area RN by being in contact with each other.

The pressure member 20 freely rotates around the second rotational axis L2. When the pressure member 20 rotates, the fixing belt 10 rotates following the pressure member 20. Through this configuration, a toner image is fixed to the paper P as the paper P passes through the fixing nip area RN. It should be noted that the paper P is conveyed in a sheet conveyance direction T (positive Z-axial direction).

In the following, a side that is upstream in the sheet conveyance direction T may be referred to as “one side in the third direction DZ”, and an opposite side thereto may be referred to as the “other side in the third direction DZ”.

Next, the configuration of the heating section 30 is further described with reference to FIGS. 5A to 6B. FIG. 5A is a perspective view of the heater holding member 32. FIG. 5B is an enlarged view of a first area R1 in FIG. 5A. FIG. 6A is a diagram illustrating the heater holding member 32 and the pair of belt holding sections 60 as viewed from a negative X-axial direction. FIG. 6B is an enlarged view of a second area R2 in FIG. 6A.

As illustrated in FIG. 5A, the heater holding member 32 has a main body portion 321 and a plurality of ridges 320. The main body portion 321 has a first wall 3211 on the other side thereof in the third direction DZ, a second wall 3212 on the one side thereof in the third direction DZ, and a bottom wall 3213. The first wall 3211 is erected from an edge of the bottom wall 3213 on the other side thereof in the third direction DZ toward the other side thereof in the second direction DX. The second wall 3212 is erected from an edge of the bottom wall 3213 on the one side thereof in the third direction DZ toward the other side thereof in the second direction DX. The first wall 3211, the second wall 3212, and the bottom wall 3213 are each plate-shaped.

The ridges 320 are disposed on the first wall 3211. The ridges 320 protrude from the first wall 3211 toward the other side thereof in the third direction DZ. As illustrated in FIG. 5B, each ridge 320 is substantially triangular as viewed from the first direction DY.

As illustrated in FIG. 5A, the first wall 3211 has a central portion PA, a first end PB, a second end PC, a first intermediate portion PD, and a second intermediate portion PE. The second end PC, the second intermediate portion PE, the central portion PA, the first intermediate portion PD, and the first end PB are formed continuously in the stated order from the one side to the other side of the first wall 3211 in the first direction DY. In the present embodiment, the first end PB of the main body portion 321 has ends of the first wall 3211 and the second wall 3212 on the other side of the main body portion 321 in the first direction DY. The second end PC of the main body portion 321 has ends of the first wall 3211 and the second wall 3212 on the one side of the main body portion 321 in the first direction DY. The first intermediate portion PD indicates an area of the first wall 3211 and the second wall 3212 from the central portion PA to the first end PB of the main body portion 321 in the first direction DY. The second intermediate portion PE indicates an area of the first wall 3211 and the second wall 3212 from the central portion PA to the second end PC of the main body portion 321 in the first direction DY. A length of each of the central portion PA, the first end PB, and the second end PC in the first direction DY is adjusted according to the size of the paper P. For example, when the size of the paper P is A4, the total length of the heater holding member 32 in the first direction DY is approximately 240 mm, and the lengths of the central portion PA, the first end PB, and the second end PC in the first direction DY are each approximately 20 mm.

The ridges 320 are arranged in the first direction DY from the first end PB to the second end PC of the first wall 3211. The ridges 320 on the central portion PA are an example of a plurality of first ridges. The ridges 320 on the first intermediate portion PD and the second intermediate portion PE are an example of second ridges. The ridges 320 on the first end PB and the second end PC are an example of third ridges. In the present embodiment, three ridges 320 are formed on the central portion PA of the first wall 3211. Three ridges 320 are formed on each of the first end PB and the second end PC of the first wall 3211.

In the present embodiment as illustrated in FIG. 6A, in the first direction DY, the ridges 320 are densely formed on an end on the one side of the first wall 3211 in the first direction DY, on an end on the other side of the first wall 3211 in the first direction DY, and in the central portion of the first wall 3211, and are sparsely formed on other parts of the first wall 3211. In other words, the interval between adjacent ridges 320 on the central portion PA, the first end PB, and the second end PC is narrower than in other areas. In the following, the interval between adjacent ridges 320 is referred to as a “ridge interval”. As illustrated in detail in FIGS. 6A and 6B, the ridge interval between the ridges 320 on the central portion PA, the first end PB, and the second end PC is a first interval d1. The ridge interval in the remaining parts is a second interval d2. Specifically, the ridge interval of the ridges 320 on the first intermediate portion PD and the second intermediate portion PE is the second interval d2. Furthermore, the ridge interval between a ridge 320 on an end on the one side of the first end PB in the first direction DY and a ridge 320 on an end on the other side of the first intermediate portion PD in the first direction DY is the second interval d2. The ridge interval between a ridge 320 on an end on the one side of the first intermediate portion PD in the first direction DY and a ridge 320 on an end on the other side of the central portion PA in the first direction DY is the second interval d2. The ridge interval between a ridge 320 on an end on the one side of the central portion PA in the first direction DY and a ridge 320 on an end on the other side of the second intermediate portion PE in the first direction DY is the second interval d2. The ridge interval between a ridge 320 on an end on the one side of the second intermediate portion PE in the first direction DY and a ridge 320 on an end on the other side of the second end PC in the first direction DY is the second interval d2.

The first interval d1 is smaller than the second interval d2. For example, the first interval d1 is half of the second interval d2. The second interval d2 is 7 mm to 10 mm, for example.

As illustrated in FIG. 6A, the ridges 320 are disposed on the second wall 3212. The ridges 320 protrude from the second wall 3212 in a direction opposite to that of the ridges 320 on the first wall 3211. The ridges 320 are formed in the first direction DY from the first end PB to the second end PC of the second wall 3212. The ridge interval of the ridges 320 on the second wall 3212 is the same as the ridge interval of the ridges 320 on the first wall 3211.

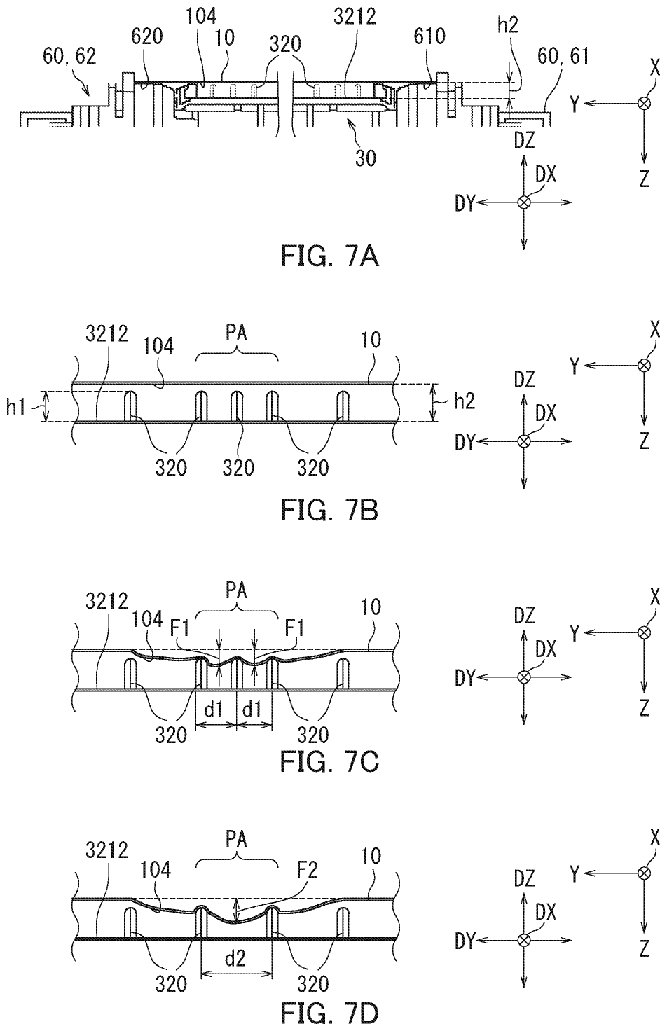

Next, the configuration of the fixing device 1 is further described with reference to FIGS. 7A to 7D. FIG. 7A is a partial cross-sectional view taken along a line VIIA-VIIA in FIG. 2. FIG. 7B is an enlarged partial cross-sectional view of ridges 320 and the fixing belt 10 of the present embodiment in the central portion PA of the heater holding member 32 in the Y-axial direction in a state where the fixing device 1 is still. FIG. 7C is an enlarged partial cross-sectional view of ridges 320 and the fixing belt 10 of the present embodiment in the central portion PA of the heater holding member 32 in the Y-axial direction in a state where the fixing device 1 is being driven. FIG. 7D is an enlarged partial cross-sectional view of ridges 320 and a fixing belt 10 of a comparative example in a central portion PA of a heater holding member 32 in the Y-axial direction in a state where a fixing device is being driven. The configuration of the fixing device of the comparative example is the same as the configuration of the fixing device 1 of the present embodiment aside from that the ridge interval on the central portion PA of the heater holding member 32 is the second interval d2.

In the state where the fixing device 1 is still as illustrated in FIG. 7A, the inner peripheral surface 104 of the fixing belt 10 is in contact with the contact section 610 of the first holding member 61 and the contact section 620 of the second holding member 62. In the state where the fixing device 1 is still, the inner peripheral surface 104 of the fixing belt 10 is out of contact with the ridges 320. That is, in the state where the fixing device 1 is still as illustrated in FIG. 7B, a height h1 of the ridges 320 from the main body portion 321 in the third direction DZ is lower than a height h2 of the contact section 610 from the main body portion 321 in the third direction DZ. The height h1 of the ridges 320 from the main body portion 321 indicates a distance in the third direction DZ from the second wall 3212 to the tips of the ridges 320. As illustrated in FIG. 7A, the height h2 of the contact section 610 from the main body portion 321 indicates a distance in the third direction DZ from the second wall 3212 to the contact section 610.

In the state where the fixing device 1 of the present embodiment is being driven, the central portion of the fixing belt 10 in the width direction DY may collapse. In particular, the central portion of the fixing belt 10 in the width direction DY easily collapses upstream in the sheet conveyance direction T. In the state where the fixing device 1 of the present embodiment is being driven as illustrated in FIG. 7C, the inner peripheral surface 104 of the central portion of the fixing belt 10 comes in contact with three ridges 320 on the central portion PA when the central portion of the fixing belt 10 in the width direction DY collapses. That is, the three ridges 320 on the central portion PA attempt to inhibit deformation of the fixing belt 10. In this case, the maximum collapse depth of the fixing belt 10 is a relatively small first depth F1.

By contrast, in the state where the fixing device of the comparative example is being driven as illustrated in FIG. 7D, the inner peripheral surface 104 of the central of the fixing belt 10 comes in contact with two ridges 320 on the central portion PA when the central of the fixing belt 10 in the width direction DY collapses. In this case, the maximum collapse depth of the fixing belt 10 is a second depth F2. The second interval d2 of the two ridges 320 on the central portion PA is wider than the first interval d1. As such, in the fixing device of the comparative example, the central portion of the fixing belt 10 in the width direction DY collapses deeper than in the fixing device 1 of the present embodiment. As such, the second depth F2 is greater than the first depth F1. As a result, in the fixing device of the comparative example, a crack occurs more easily in the fixing belt 10 than in the fixing device 1 of the present embodiment.

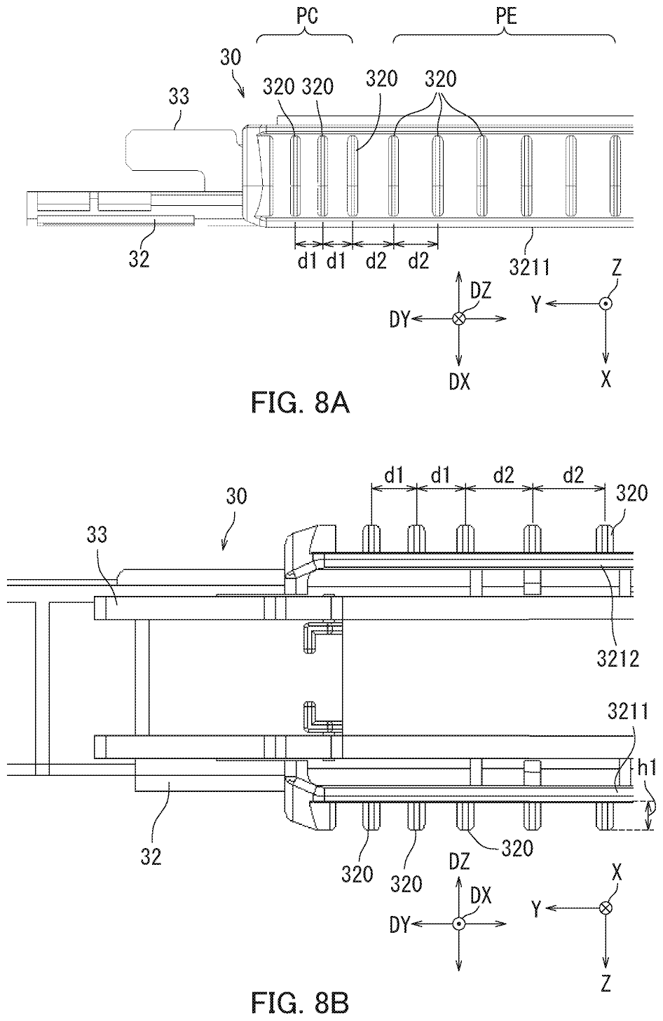

Next, the configuration of the heating section 30 of the present embodiment is further described with reference to FIGS. 8A to 8B. FIG. 8A is an enlarged view of a side of the second end PC of the heater holding member 32 as viewed from the positive Z-axial direction. FIG. 8B is a diagram illustrating a side of the second end PC of the heater holding member 32 as viewed from the negative X-axial direction.

As illustrated in FIGS. 8A and 8B, the ridges 320 are disposed on the first wall 3211 and the second wall 3212. As illustrated in detail with reference to FIG. 6A, adjacent ridges 320 are disposed separated by the first interval d1 in the first direction DY in the second end PC. Adjacent ridges 320 are disposed separated by the second interval d2 in the first direction DY on the second intermediate portion PE. Furthermore, a ridge 320 positioned on an end on the other side of the second end PC in the first direction DY and a ridge 320 positioned on an end on the one side of the second intermediate portion PE in the first direction DY are disposed separated by the second interval d2.

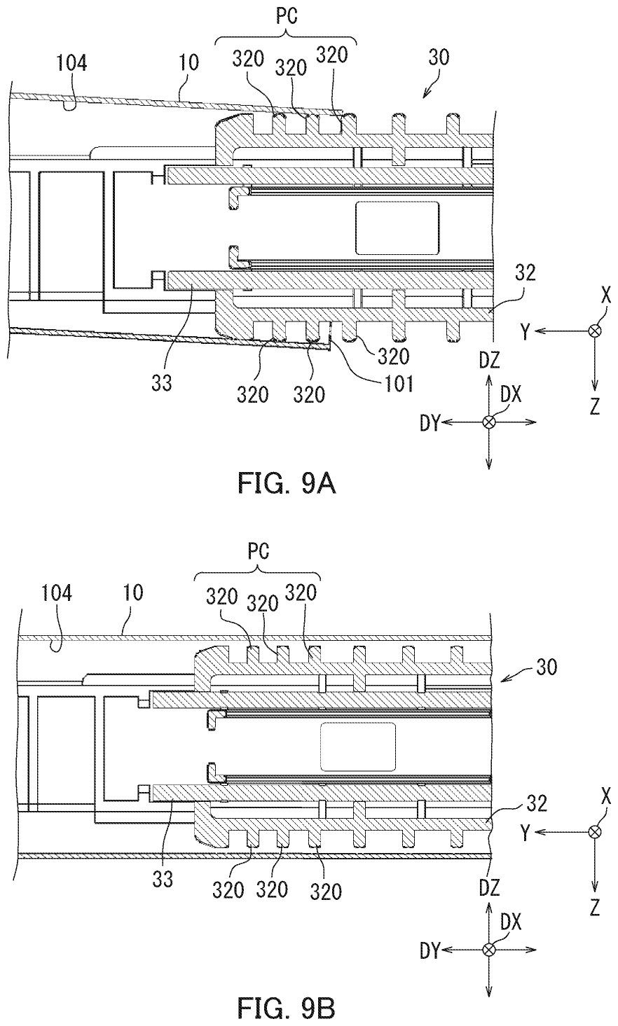

The fixing belt 10 and the heating section 30 of the present embodiment are described with reference to FIGS. 9A and 9B. FIG. 9A is a cross-sectional view of a state where the heater holding member 32 is being inserted into the fixing belt 10 from a side of the second end PC of the heater holding member 32. FIG. 9B is a cross-sectional view of a state where the heater holding member 32 has been inserted into the fixing belt 10. It should be noted that FIGS. 9A and 9B are diagrams illustrating a cross section of the fixing belt 10 in the width direction DY as viewed from the negative X-axial direction.

A worker moves the heating section 30 in the width direction DY of the fixing belt 10. Therefore, the heating section 30 can be disposed inside of the inner peripheral surface 104 of the fixing belt 10. It should be noted that the fixing belt 10 is thin and easily torn. As such, a machine cannot insert the heating section 30 into the inner peripheral surface 104 of the fixing belt 10.

In detail, the heating section 30 is inserted into the fixing belt 10 as described in the following. First, the worker presses a finger on a part of the fixing belt 10 separated from the first edge 101 by a prescribed distance. When the fixing belt 10 is pressed, the first edge 101 of the fixing belt 10 deforms. In detail, when the first edge 101 of the fixing belt 10 is pressed in the second direction DX, the first edge 101 of the fixing belt 10 is deformed into an elliptical shape that is long in the third direction DZ. When the first edge 101 of the fixing belt 10 widens, the heating section 30 is easily inserted from the first edge 101 of the fixing belt 10.

Next, the worker inserts the heating section 30 from the first edge 101 of the fixing belt 10. As illustrated in FIG. 9A, when the heating section 30 is inserted into the fixing belt 10, the ridges 320 of the second end PC comes in contact with the inner peripheral surface 104 of the fixing belt 10. In this case, because the ridge interval of the ridges 320 on the second end PC is the first interval d1 in the present embodiment, it is difficult for the ridges 320 on the second end PC to catch the first edge 101 of the fixing belt 10 as compared to a case where the ridge interval of the ridges 320 on the second end PC is the second distance d2. As such, the worker can easily insert the heating section 30 into the fixing belt 10. Once the heating section 30 is inserted into the first edge 101 of the fixing belt 10 as illustrated in FIG. 9B, the worker can insert the remaining part of the heating section 30 into the fixing belt 10 in a stable manner without making contact with the first edge 101 of the fixing belt 10.

As described with reference to FIGS. 1 to 9B, a fixing device 1 includes a fixing belt 10 and a heating section 30. The heating section 30 includes a heater 31 and a heater holding member 32. The heater holding member 32 has a main body portion 321 and a plurality of ridges 320. The ridges 320 include a plurality of first ridges 320 and a plurality of second ridges 320. The first ridges 320 are a plurality of ridges 320 formed on a central portion PA. The second ridges 320 are a plurality of ridges 320 formed on a first intermediate portion PD and a second intermediate portion PE. The first ridges 320 are disposed separated by a first interval d1. The second ridges 320 are disposed separated by a second interval d2. The first interval d1 is smaller than the second interval d2. Therefore, in the fixing device 1, it is more difficult for the inner peripheral surface 104 of the fixing belt 10 to come in contact with the ridges 320 on the first intermediate portion PD and the second intermediate portion PE while the fixing device 1 is being driven than in a case where the ridges 320 on the first intermediate portion PD and the second intermediate portion PE are disposed separated at the first interval d1. As such, a burden on the fixing belt 10 and the heater holding member 32 in sliding can be reduced in the fixing device 1. As a result, the fixing device 1 can inhibit occurrence of a heating defect or a conveyance defect in the fixing belt 10. Furthermore, in the fixing device 1, the inner peripheral surface 104 of the fixing belt 10 more easily comes in contact with the ridges 320 on the central portion PA when the central portion of the fixing belt 10 in a width direction DY thereof collapses while the fixing device 1 is being driven than in a case where the ridges 320 on the central portion PA are disposed separated by the second interval d2. Therefore, the size of the collapse of the central portion of the fixing belt 10 in the width direction DY can be made small in the fixing device 1. As a result, the fixing device 1 can inhibit occurrence of a crack in the fixing belt 10.

As described with reference to FIGS. 1 to 9B, the ridges 320 further include a plurality of third ridges 320. The third ridges 320 are a plurality of ridges 320 formed on a first end PB and a second end PC. The third ridges 320 are disposed separated at the first interval d1. Therefore, in the fixing device 1, it is more difficult for the ridges 320 on the second end PC or the ridges 320 on the first end PB to catch the first edge 101 or the second edge 102 of the fixing belt 10 when the heating section 30 is inserted into the fixing belt 10 than in a case where the ridge interval of the ridges 320 formed on the first end PB and the second end PC is the second interval d2. As a result, the fixing device 1 allows a worker to easily insert the heating section 30 into the fixing belt 10 from either the first edge 101 or the second edge 102 of the fixing belt 10.

As described with reference to FIGS. 1 to 9B, the fixing device 1 further includes a pair of belt holding sections 60. A height h1 of the ridges 320 from the main body portion 321 in a third direction DZ is lower than a height h2 of a contact section 610 or a contact section 620 from the main body portion 321 in the third direction DZ. Therefore, while the fixing device 1 is being driven, the inner peripheral surface 104 of the fixing belt 10 is usually out of contact with the ridges 320. As such, a burden on the fixing belt 10 and the heater holding member 32 in sliding can be reduced in the fixing device 1.

An embodiment of the present disclosure is described above with reference to FIGS. 1 to 9B. However, the present disclosure is not limited to the above embodiment and may be implemented in various manners within a scope not departing from the gist thereof (for example, as illustrated below in (1) to (4)). The drawings mainly illustrate elements of configuration schematically to facilitate understanding. Aspects such as thickness, length, and number of the elements of configuration illustrated in the drawings may differ in practice for convenience of drawing preparation. Furthermore, aspects such as material, shape, and dimension of the elements of configuration illustrated in the above embodiment are merely examples and not particular limitations. The elements of configuration may be variously altered within a scope not substantially departing from the effects of the present disclosure.

(1) In the embodiment of the present disclosure as described with reference to FIGS. 1 to 9B, the image forming apparatus 100 is a monochrome multifunction peripheral. However, the present disclosure is not limited as such. The image forming apparatus 100 may be a monochrome printer, for example. Alternatively, the image forming apparatus 100 may be a color multifunction peripheral or a color printer.

(2) In the embodiment of the present disclosure as described with reference to FIGS. 1 to 9B, the ridge interval of the ridges 320 on the central portion PA, the first end PB, and the second end PC is the first interval d1. However, the present disclosure is not limited as such. For example, only the ridge interval of the ridges 320 on the central portion PA may be the first interval d1, and the ridge interval of the remaining ridges 320 may each be the second interval d2 or larger.

(3) In the embodiment of the present disclosure as described with reference to FIGS. 1 to 9B, the ridge interval of the ridges 320 on the first end PB and the second end PC is the first interval d1. However, the present disclosure is not limited as such. For example, the ridge interval of the ridges 320 on the first end PB and the second end PC may be an interval differing from the first interval d1 and smaller than the second interval d2. Furthermore, the ridge interval of the ridges 320 on either one of the first end PB or the second end PC may be the second interval d2 or larger.

(4) In the embodiment of the present disclosure as described with reference to FIGS. 1 to 9B, three ridges 320 are formed on each of the central portion PA, the first end PB, and the second end PC of each of the first wall 3211 and the second wall 3212. However, the present disclosure is not limited as such. For example, the ridges 320 disposed on the central portion PA of each of the first wall 3211 and the second wall 3212 may be two, or four or more in number. Furthermore, the ridges 320 disposed on the first end PB and the second end PC of each of the first wall 3211 and the second wall 3212 may be two, or four or more in number.

What is claimed is:

1. A fixing device comprising:
a fixing belt that is endless; and
a heating section facing an inner peripheral surface of the fixing belt, wherein,
the heating section includes:
a heater which applies heat to the fixing belt; and
a heater holding member which holds the heater,
the heater holding member has:
a main body portion; and
a plurality of ridges which regulate a shape of the fixing belt,
the ridges protrude from the main body portion,
the ridges include:
a plurality of first ridges disposed on a central portion of the main body portion in a width direction of the fixing belt; and
a plurality of second ridges disposed in an area of the main body portion at least partially extending, in the width direction of the fixing belt, from the central portion to each of opposite ends of the main body portion,
the first ridges are disposed separated at a first interval,
the second ridges are disposed separated at a second interval, and
the first interval is smaller than the second interval.

2. The fixing device according to claim 1, wherein
the ridges further include a plurality of third ridges disposed on at least one end of the main body portion in the width direction of the fixing belt,
the third ridges are disposed separated at a third interval, and
the third interval is smaller than the second interval.

3. The fixing device according to claim 1, wherein
the ridges further include a plurality of third ridges disposed on both ends of the main body portion in the width direction of the fixing belt,
the third ridges are disposed separated at a third interval, and
the third interval is smaller than the second interval.

4. The fixing device according to claim 1, further comprising
a belt holding section which rotatably holds the fixing belt, wherein
the belt holding section includes a contact section which is in contact with the fixing belt, and
a height of the ridges from the main body portion in a direction orthogonal to the width direction of the fixing belt is lower than a height of the contact section from the main body portion in the direction orthogonal to the width direction of the fixing belt.

5. The fixing device according to claim 1, wherein
the heater is a planar heater.

6. An image forming apparatus comprising:
the fixing device according to claim 1; and
an image forming section configured to form a toner image on a recording medium, wherein
the fixing device fixes the toner image to the recording medium.
